(19) United States
(12) Patent Application Publication
(10) Pub. No.: US 2003/0036976 A1
(43) Pub. Date: Feb. 20, 2003

(54) System and method for providing business transaction information in multiple languages

(76) Inventor: Kurt De Ruwe, Kontich (BE)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/929,391

(22) Filed: Aug. 14, 2001

(51) Int. Cl. G06F 17/60

(52) U.S. Cl. 705/27

(57) ABSTRACT

A method for providing business transaction information in different languages comprises receiving an electronic document containing business transaction information in words and/or characters of a first language. The business transaction information is saved into fields of a database based on certain categories of the business transaction information. The business transaction information in at least some of the fields is translated to a second language by performing a look-up in the database to determine corresponding words and/or characters of the second language. An electronic document having at least some of the business transaction information is produced in the second language.

### BACKGROUND OF THE INVENTION

This invention relates generally to the field of business transactions, and in particular to the documents used in such business transactions. More specifically, the invention relates to the translation of business transaction information that is contained in such documents into one ore more languages.

Many companies utilize computer systems to facilitate the operation and management of various aspects of their business. For example, many companies use computer systems to facilitate purchasing, order fulfillment, billing, scheduling, inventory management, record keeping, and the like. Because many businesses have similar requirements, a variety of business applications systems having various business applications software packages have been developed. Merely by way of example, one such system is the SAP business applications software package.

Like other similar software packages, SAP is able to execute various business transaction functions such as order processing, inventory control, invoice validation, financial accounting, production planning and control, and the like. Such a software package may be in the form of various modules that are integrated to perform their various functions. As one example, the SAP software package provides the ability to enter a request to purchase a specific item. This request may then be sent to a warehouse for order fulfillment in the form of a purchase order. Also, the SAP system may generate and send to the client an order confirmation. Further, information may be sent to the accounting department for billing.

In today's global economy, many companies do business throughout the world. Unfortunately, a wide variety of languages are used throughout the world which can make business transactions more difficult in a global transaction. For example, a customer in China that orders a product from the United States would like to receive an order confirmation in Chinese, rather than English. However, current business application systems are ill suited for making such accommodations.

Hence, this invention is related to systems and techniques for translating business transaction information into different languages. In this way, business transactions between parties speaking different native languages may be facilitated.

### SUMMARY OF THE INVENTION

In one embodiment, the invention includes a method for providing business transaction information in different languages. According to the method, business transaction information is input into a computer in a first language. As is customary, the business transaction information may be input in the form of words and/or characters of the first language. The business transaction information is saved into fields of a database based on certain categories of the business transaction information. The business transaction information in at least some of the fields is translated into a second language by performing a look-up in the database to determine corresponding words and/or characters of the second language. Further, a document is produced having at least some of the business transaction information in the second language. In this way, business transaction information may be input in a first language, and various documents relating to the business transaction may be produced having at least some of the terms in the second language.

Merely by way of example, the business transaction information may comprise an order to purchase an item, and the document produced may comprise a confirmation of the order, with terms of the confirmation being in the second language. With such a configuration, a company may take an order from a customer that generally uses a language that is different from that used by the company. The company employee may input the request into a computer system in a language familiar to the employee. Conveniently, the employee's computer screen may include display screens with various boxes for inputting the order information in the employee's preferred language. According to the invention, an order confirmation may then be produced in the customer's preferred language and sent to the customer. For example, the order confirmation may be printed and faxed to the customer. Alternatively, the order confirmation may be sent in electronic form, such as by an e-mail.

The business transaction information may be categorized into a wide variety of fields depending on the nature of the transaction. Such fields may include, for example, customer names, product names, product descriptions, addresses, and the like. Each of these fields may be translated by performing a one-to-one look-up in the database, i.e. a search is performed to find a corresponding word or character in the database. Merely by way of example, the fields may be translated from English to a Far Eastern language, such as Chinese by determining equivalent Chinese characters for each English word.

In another embodiment, the invention provides a system for translating business transaction information into different languages. The system comprises a database having a collection of certain words and/or characters from a first language and counterpart words and/or characters from one or more other languages. The system further includes computer code to translate words and/or characters from fields having business transaction information from the first language to a second language. Computer code is also used to produce an electronic document containing at least some of the business transaction information in the second language. In this way, the system may take input business transaction information and produce a document relating to the business transaction which includes relevant terms in another language.

For example, such business transaction information may be input using an electronic input device, such as a computer. A printer or other output device may then be used to print the produced electronic document. In this way, business transaction information, such as an order to purchase an item, may be input into a computer using the first language, and a confirmation of the order may be printed in the second language. As will be appreciated, the system may include various software packages to produce a wide variety of documents that relate to the business transaction. By way of example, such documents may include sales documents, such as order confirmations and order acknowledgments, shipping documents, such as delivery notes, dangerous goods notes, transport booking forms, cancellations, consignment notes, certificates of analysis, certificates of conformity, consignee distribution data, shipper's declarations for dangerous goods, shipping notes, packing lists, certificates of origin, and weight memos, picking and loading lists, billing documents, such as invoices, invitations to invoice suppliers, and payment orders, purchasing documents, such as purchase orders, and the like. These documents may include fields such as customer names, product names, product descriptions, addresses, other data and the like, and such terms may each be translated into another language.

### BRIEF DESCRIPTION OF THE DRAWINGS

FIG. 1 is a schematic diagram of a system for performing various business transactions in various languages according to the invention.

FIG. 2 is a flow chart illustrating one method for translating business transaction information according to the invention.

FIG. 3 illustrates an order creation screen that may be used when entering an order into the system of FIG. 1 according to the invention.

FIG. 4 illustrates a selection list screen that may be used to select items to purchase using the system of FIG. 1 according to the invention.

FIG. 5 illustrates a purchase order screen that may be used to enter a customer's purchase order number using the system of FIG. 1 according to the invention.

FIG. 6 illustrates a shipping details screen that may be used to entering shipping information using the system of FIG. 1 according to the invention.

FIG. 7 illustrates a purchase order document produced using the techniques of the invention.

FIG. 8 illustrates an invoice document produced using the techniques of the invention.

FIG. 9 illustrates an order acknowledgment document produced using the techniques of the invention.

FIG. 10 illustrates a certificate of analysis document produced using the techniques of the invention.

FIG. 11 illustrates an international consignment note produced using the techniques of the invention.

FIG. 12 illustrates one example of a booking form having the business transaction terms translated into Chinese according to the invention.

FIG. 13 illustrates one example of a sales order confirmation document having the business transaction terms translated into Chinese according to the invention.

### DESCRIPTION OF THE SPECIFIC EMBODIMENTS

The invention provides for the translation of certain business transaction information into different languages so that a customer may obtain one or more documents relating to a business transaction in a language preferred by the customer. Such documents may be produced using a business applications system where various business transactions are facilitated by the use of one or more computer systems that utilize one or more business applications software packages. Such business applications software packages may include, for example, SAP business application software, commercially available from SAP AG, Germany. However, it will be appreciated that the invention is not intended to be limited for use with any specific type of business applications software package.

As is known in the art, such business applications systems utilize computers to facilitate various types of business transactions, such as sales, billing, order fulfillment, inventory management and control, accounting, and the like. When utilizing such systems, various transactional information may be input and saved. Such information may conveniently be input using a keyboard, voice recognition system, or the like. For instance, a customer's order may be taken over the telephone and then typed into a computer using a keyboard.

Once the information in input, the business application system may produce various documents relating to a given transaction. Merely by way of example, such documents may include sales documents, such as order confirmations and order acknowledgments, shipping documents, such as delivery notes, dangerous goods notes, transport booking forms, cancellations, consignment notes, certificates of analysis, certificates of conformity, consignee distribution data, shipper's declarations for dangerous goods, shipping notes, packing lists, certificates of origin, and weight memos, picking and loading lists, billing documents, such as invoices, invitations to invoice suppliers, and payment orders, purchasing documents, such as purchase orders, and the like.

Typically, the business transaction information is entered into the application system using a language familiar to the person inputting the information. For example, much of the world is English speaking, and the system may be configured to receive input information in English. However, a customer or other person involved in a business transaction would like to view information regarding the transaction in a more familiar language, such as Chinese. According to the invention, such information is provided in one or more languages that are different than the language in which the information was originally input.

The business transaction information is translated by performing a simple one-to one translation. This may be accomplished by use of a translations database having information on various words and/or characters from different languages that each describe the same object or event. For example, the database may have a list of products that are available for purchase. These may each be stored in a certain field of the database. A corresponding field is provided for each product with the name of the product being in a different language. Other terms that may be translated into different languages include addresses, weight, quantity, customer name, shipping terms, contact information, and the like. In this way, a word and/or character in one language may easily be translated into the corresponding word and/or character of another language by performing a simple one-to-one look-up in the database. Because the business documents being produced are typically business forms, a simple one-to-one translation of certain words is a sufficient translation. For example, if the business form is an order confirmation, the types of information that would need to be translated would be the name and quantity of the ordered product, the order date, the place and time of shipment, and the like. Such business terms lend themselves to a one-to-one translation. All other information can be part of a standard pre-translated form.

Once the document has been generated in electronic form, it may be provided to a customer in a variety of ways. For example, the document may be printed and then mailed or faxed to the customer. Alternatively, the document may be sent by e-mail or by another electronic delivery system.

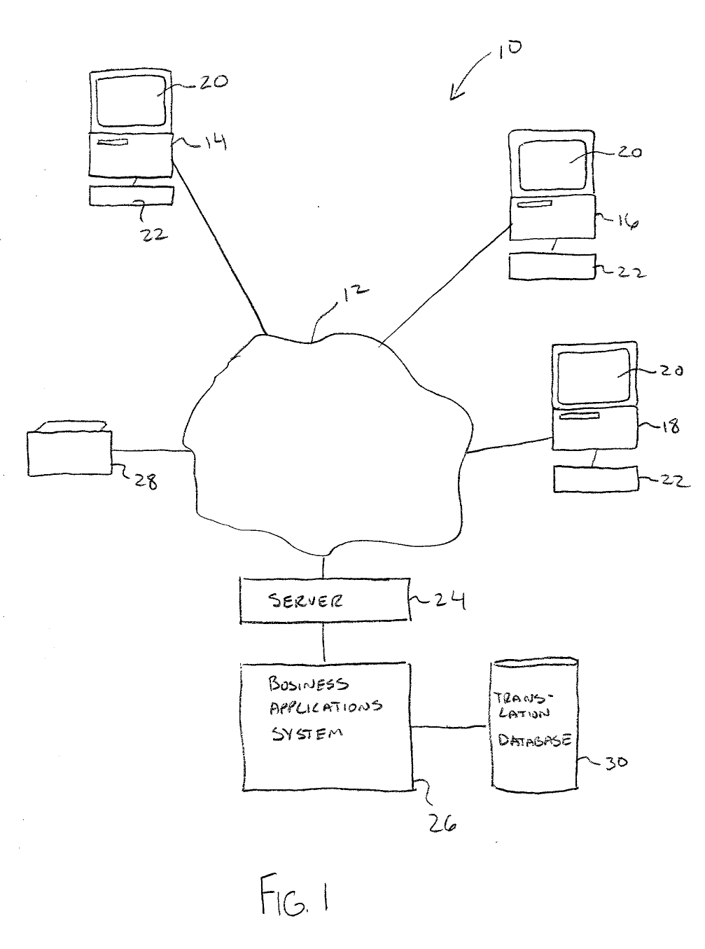

Referring now to FIG. 1, one embodiment of a system 10 for performing various business transactions in multiple languages will be described. System 10 operates in a network environment, illustrated generally by reference numeral 12. The network may be any type of network that links various computers together, including, for example, the Internet, an intranet, a local area network, a wide area network, a wireless network, and the like. Various computers 14, 16 and 18 are coupled to network 12 to facilitate the entry and/or handling of various business transactions. Merely by way of example, computer 14 may be an order entry computer, computer 16 may be a computer in the accounting department, and computer 18 may be for inventory management. However, it will be appreciated that any number of computers may be coupled to network 12 depending on the type of business transactions in which the organization is involved. Further, computers 14, 16 and 18 may be any type of input and/or processing device that is capable of communicating with a network. Merely by way of example, such computers may comprise desk top personal computers, laptop computers, mobile phones with microbrowsers, personal digital assistants, and the like. As shown, computers 14, 16 and 18 each have a display screen 20 for displaying various information and may include Windows-type software and have a web browser to view web documents. These computers may also include a keyboard 22 for entering and/or manipulating various information. These computers may also use various pointing devices, such as a mouse, as is known in the art. Other components that may be used include hard drives, disc drives, memory devices and the like as is known in the art.

System 10 further includes a server computer 24 that facilitates communication of computers 14, 16 and 18 with a business applications system 26 over network 12. Applications system 26 may comprise a mainframe computer or other suitable hardware which runs one or more modules of a business applications software package. One such example is the SAP software package, commercially available from SAP AG. The modules perform various business functions of the organization, such as order processing, inventory control, invoicing, accounting, inventory management and control, production planning and control, and the like. Hence, by utilizing computers 14, 16 and 18, various departments of an organization or company may perform various business transactions over network 12. Various output devices, such as a printer 28 may also be coupled to network 12 to output documents related to the business transactions.

Merely by way of example, system 10 may be used to input and processes an order to purchase an item. In this example, a customer may contact a sales agent who enters an order for an item into computer 14. Conveniently, computer 14 may display a purchase order form on display screen 20 that is filled in by the sales agent. The purchase order form is transmitted to applications system 26 where a purchase order is generated. This may be accessed by the shipping department using one of the computers, or a paper document may be produced. A purchase order confirmation may also be produced and sent to the customer. When the item is shipped, applications system 26 may generate and send an invoice to the customer.

One important part of system 10 is the use of a translation database 30 that is used to translate certain business transaction information into different languages so that various documents may be sent to a customer in a preferred language of the customer. Database 30 may comprise any one of a variety of relational databases, such as an Oracle database.

Information input into applications system 26 may be input into various computerized forms. These forms include various categories of information, such as customer name, shipping and billing addresses, product names and descriptions, and the like. The information in each category may be saved in a separate data field within database 30. Further, database 30 may be configured to have a list of words and/or characters from one or more languages that correspond to the words and/or characters in the various data fields. In this way, the information in each category may easily be translated by simply performing a look-up for the corresponding word and/or characters of the desired language. This information may then be inserted into a new form having the same overall appearance, but in the preferred language.

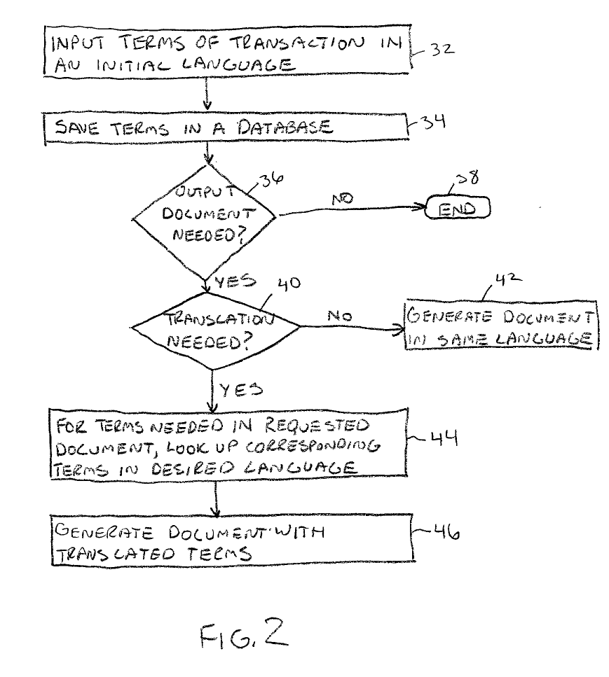

Referring now to FIG. 2, one example of how business transaction information may be provided in different languages will be described. Initially, the terms of a business transaction are input into the business applications system as illustrated in step 32. The terms of the transaction are saved in a database as shown in step 34. The system provides the user with the option of producing various documents that relate to the transaction as shown in step 36. If one of these documents is not needed, the process ends at step 38. If a user requests one of these documents, the user is also queried as to whether the document is to be produced in another language as shown in step 40. If no translation is needed, the document is generated in the same language in which the terms were initially input as shown in step 42.

If a different language is requested, the process proceeds to step 44 where the terms that are needed in the requested document are translated by looking up the corresponding terms in the desired language. In step 46 the document is generated in the desired language.

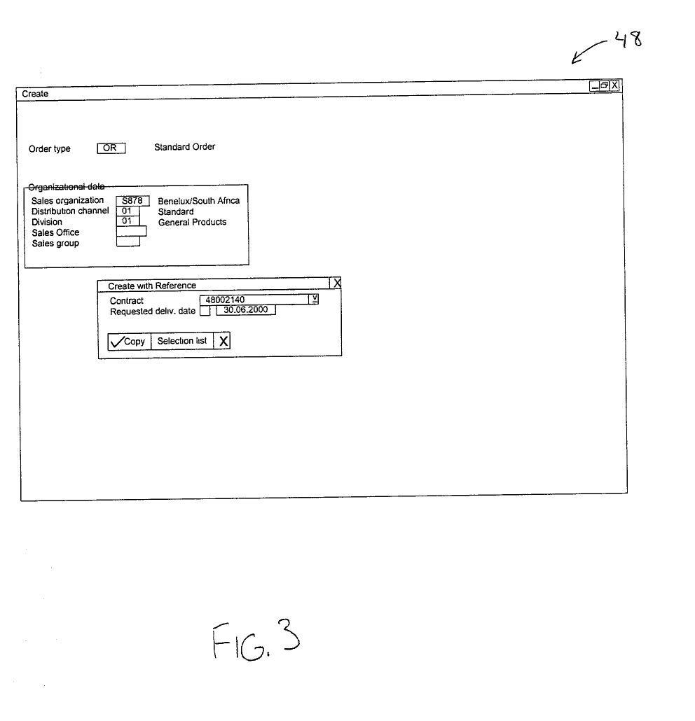

Referring now to FIGS. 3-6, one specific example of how to input information relating to the purchase of an item into system 10 will be described. In so doing, it will be appreciated that the invention is not intended to be limited to this specific example. In the example of FIGS. 3-6, an order is being taken using computer 14, with various screen displays being displayed on screen 20. Shown in FIG. 3 is an order creation screen 48 which includes various boxes for entering information regarding the order. For example, creation screen 48 includes boxes for entering the relevant order type, such as a standard order “OR”, the sales organization, and the distribution channel. A separate window may be used to input a reference to an existing contract, such as the contract number, and the requested delivery date.

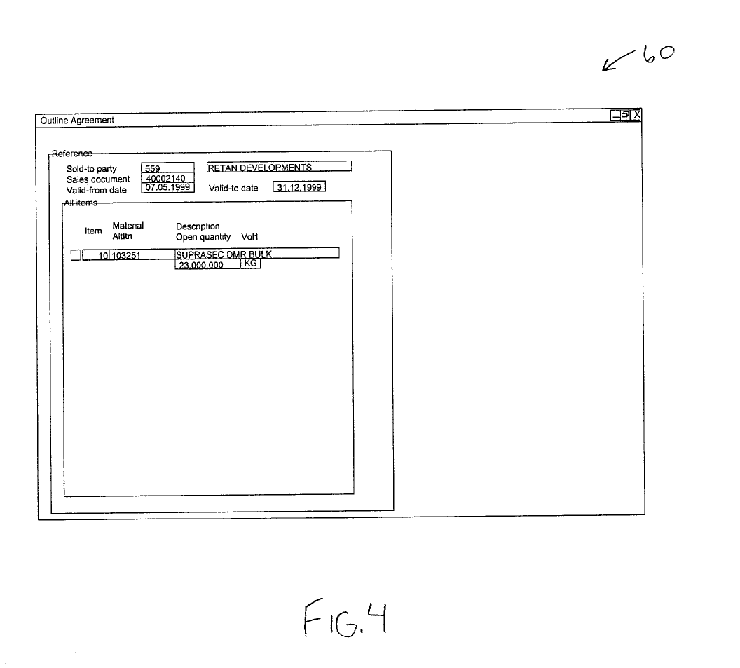

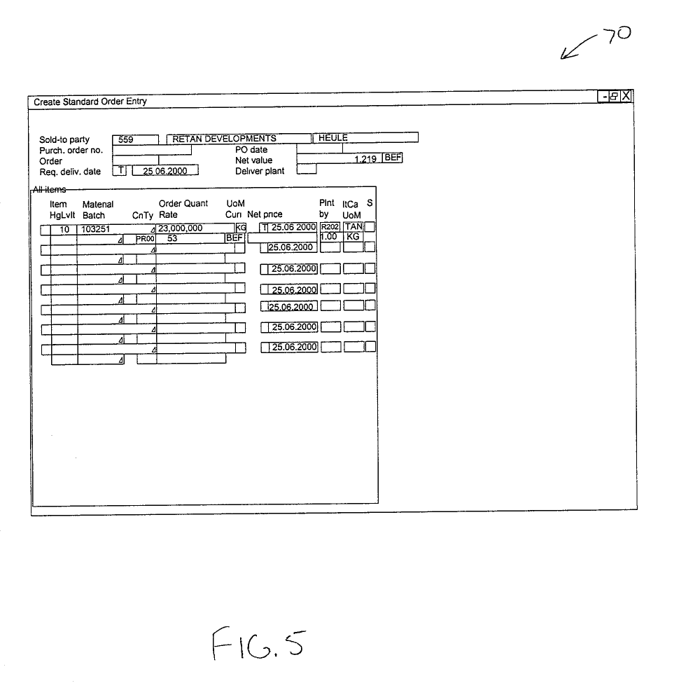

To facilitate the selection of an item to be purchased, a selection list button or icon may be selected to take the user to a selection list screen 60 as illustrated in FIG. 4. Screen 60 automatically selects the items listed in the contract, and items that the user does not wish to purchase may be deselected. FIG. 5 illustrates a purchase order screen 70 where the purchase order may be entered. Screen 70 also includes an overview of the ordering information.

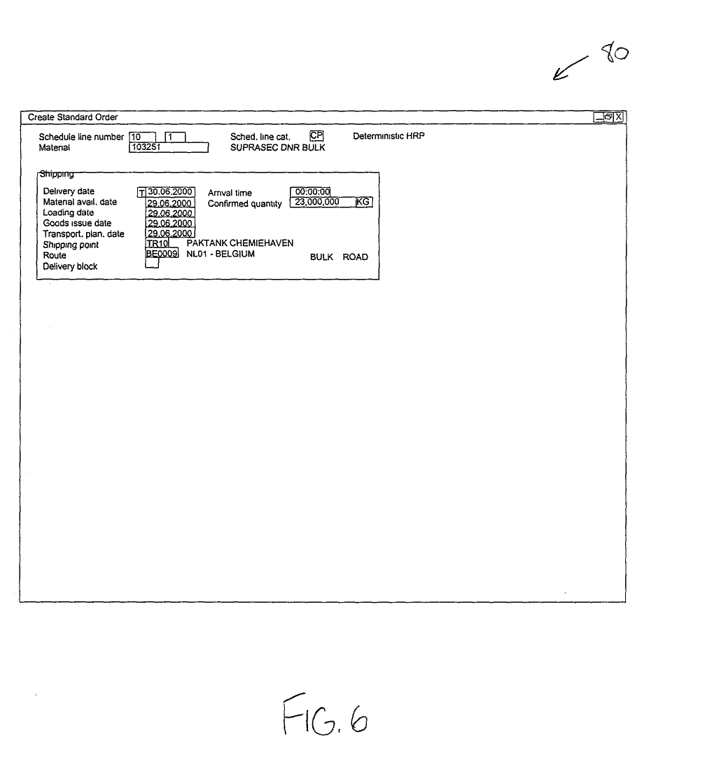

Once the ordering information has been input, a scheduling icon may be selected to produce a shipping details screen 80 as illustrated in FIG. 6. This screen may be used to enter information on delivery date, loading dates, goods issue date, and the transportation plan date.

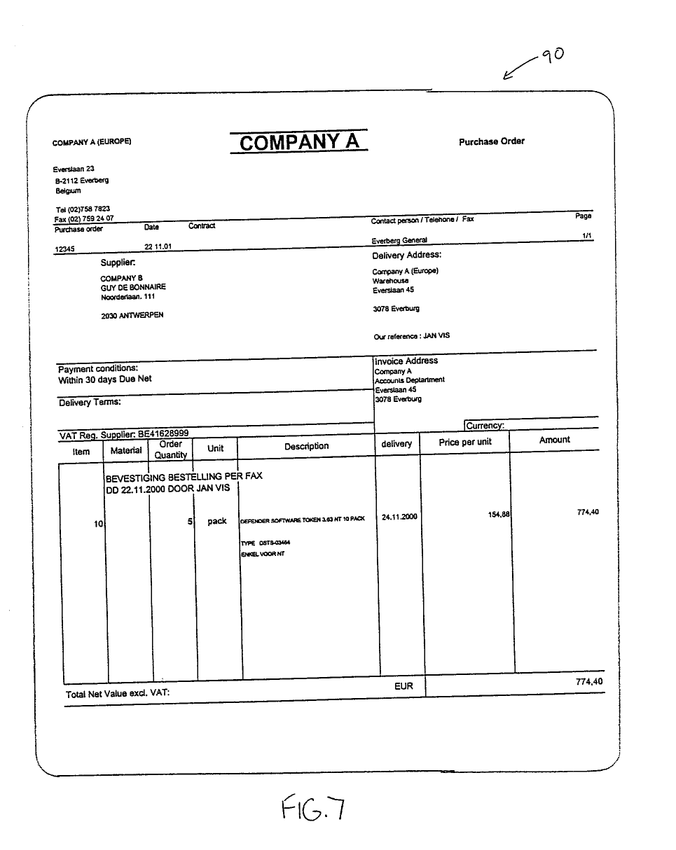

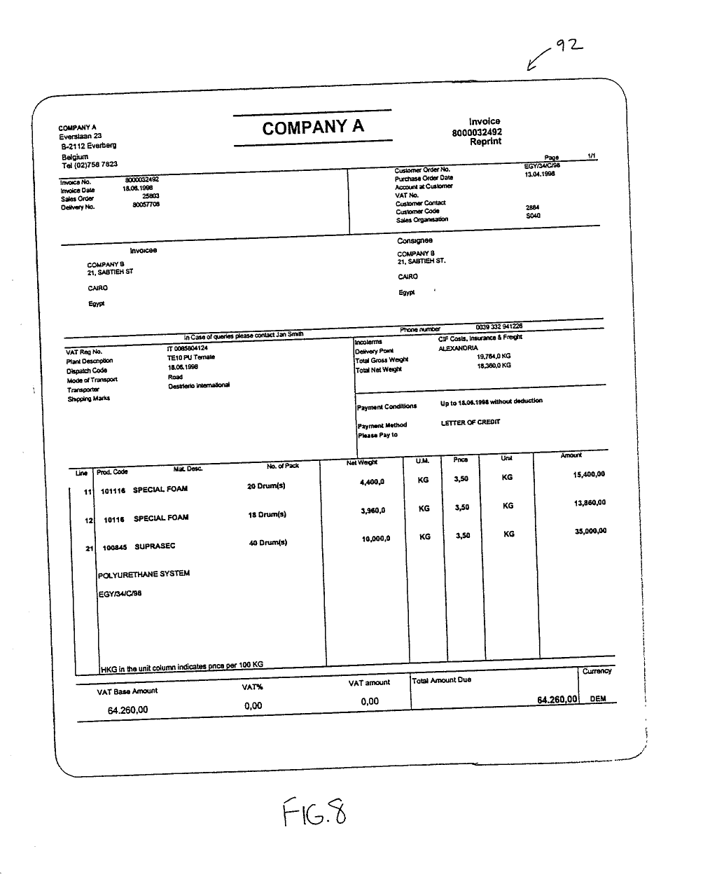

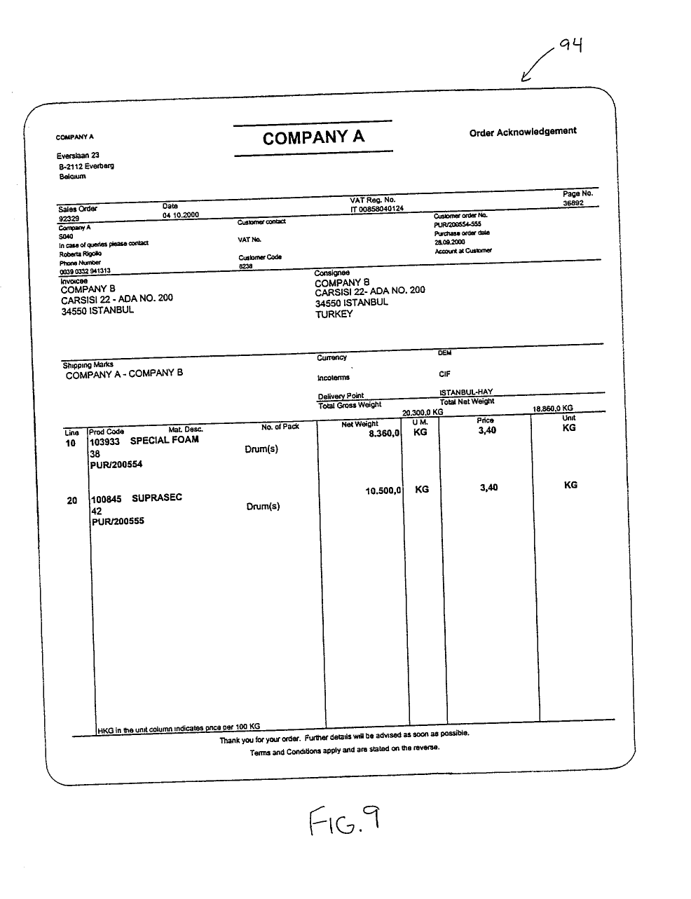

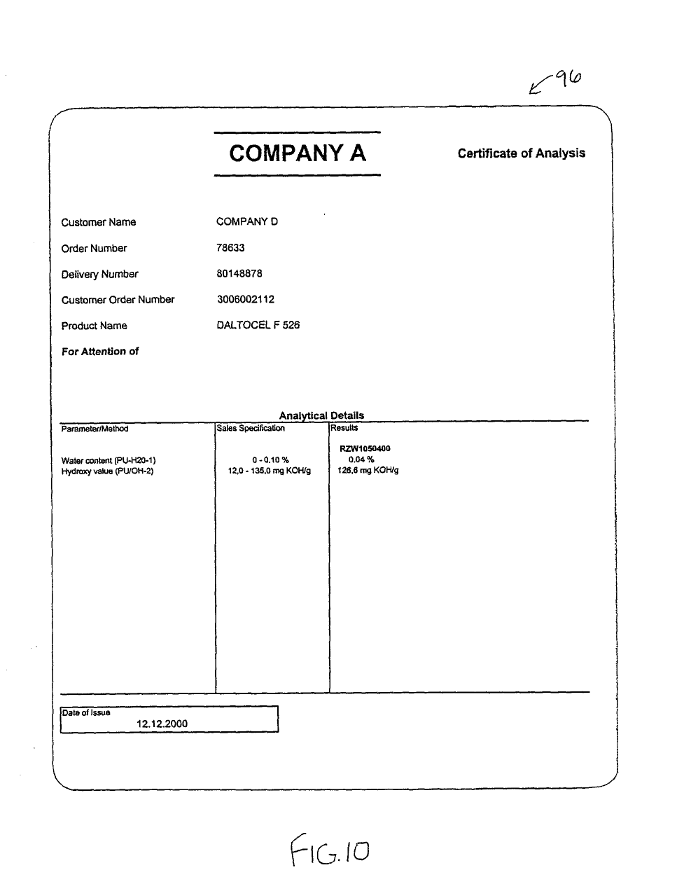

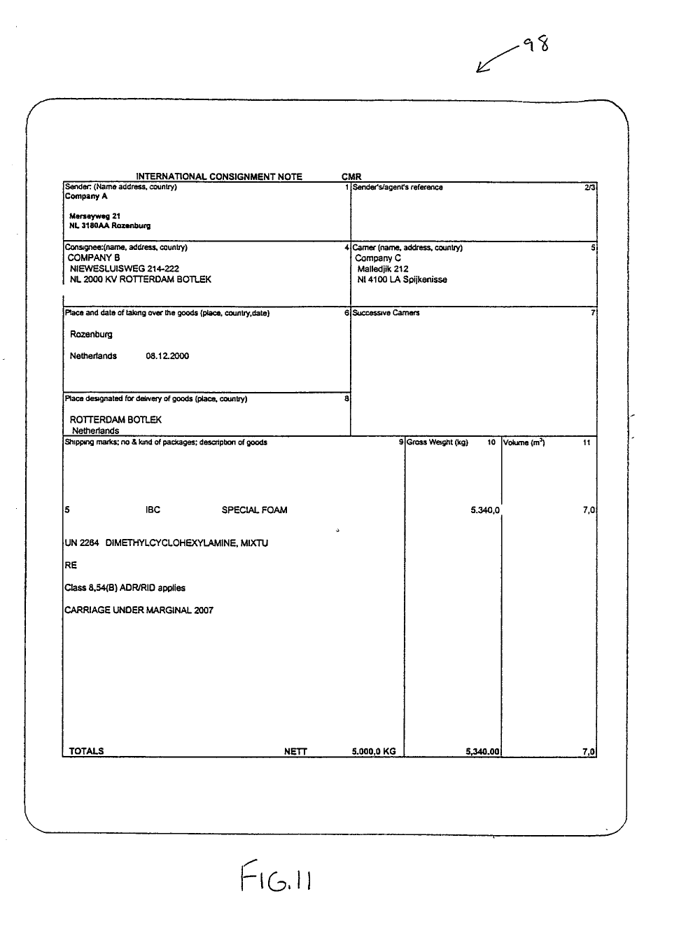

Once the business transaction information has been entered, various documents, such as reports, confirmations, and the like may be generated. Some examples of such documents are illustrated in FIGS. 7-11, it being appreciated that various other documents used in commercial transactions may also be produced. More specifically, FIG. 7 illustrates a purchase order document 90 that may be generated using system 26. FIG. 8 illustrates an invoice document 92 that may be produced using system 26. FIG. 9 illustrates an order acknowledgment document 94 that may be produced using system 26. FIG. 10 illustrates a certificate of analysis document 96 that may be generated using system 26, and FIG. 11 illustrates an international consignment note 98 that may be produced using system 26.

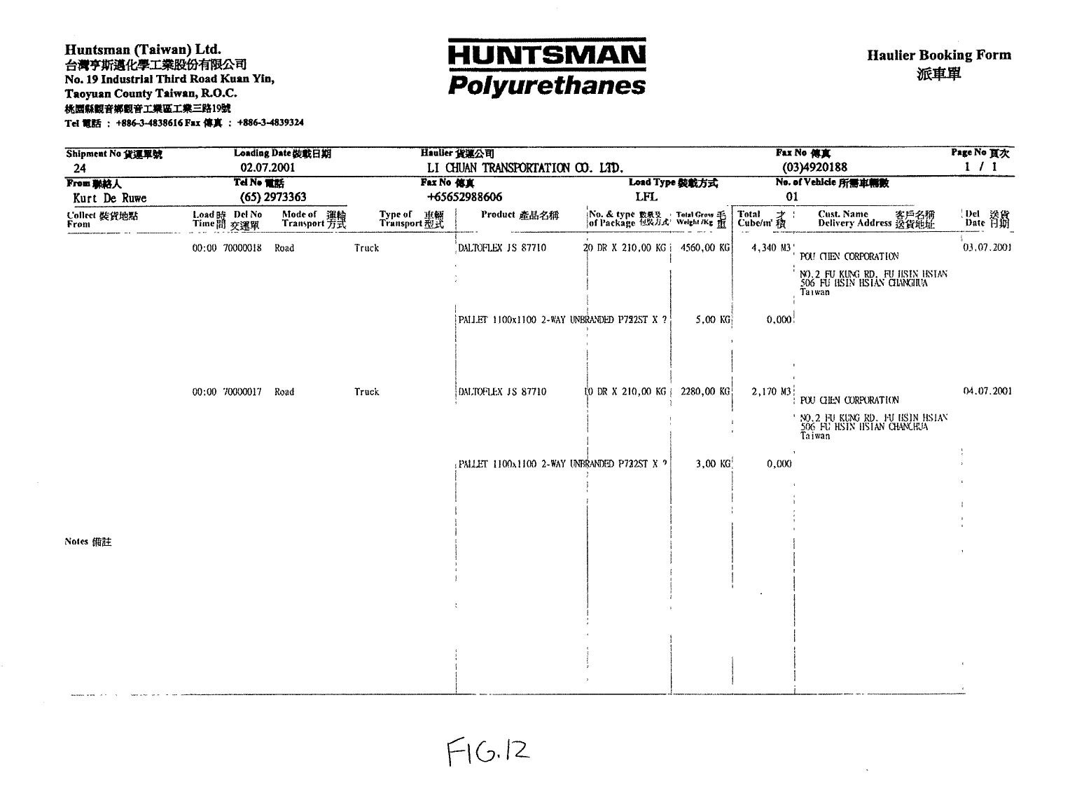

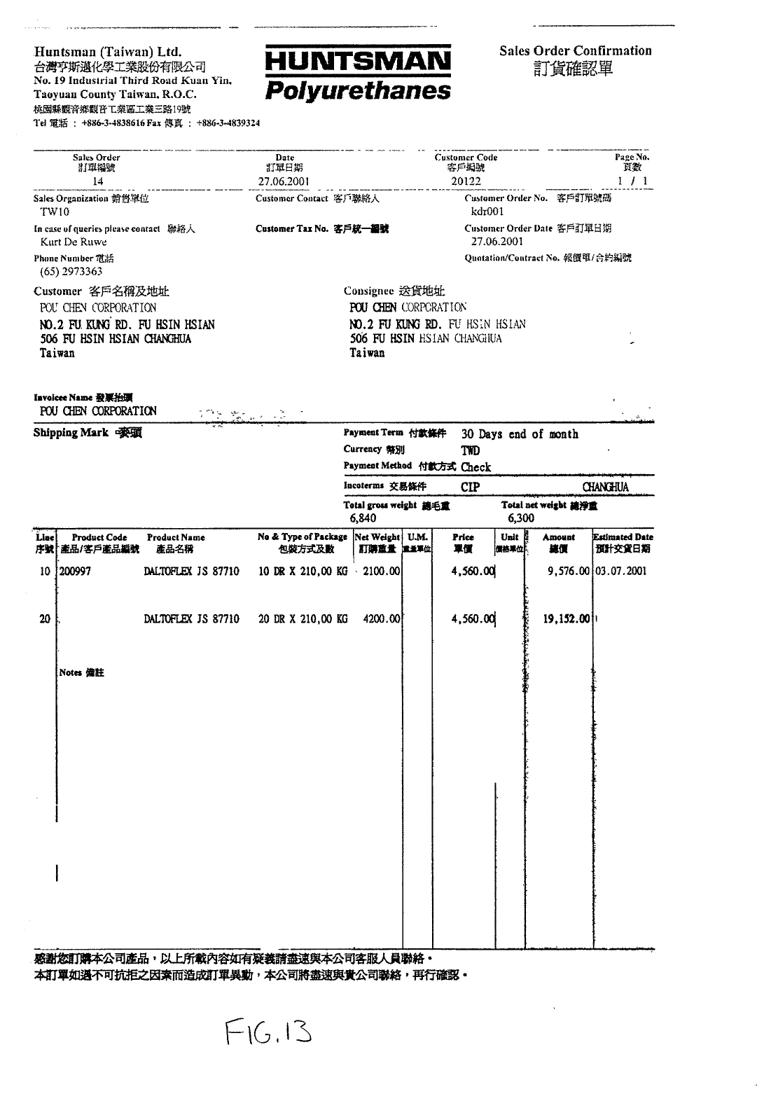

Any of the documents produced by system 26 may be translated into different languages as previously described. Optionally, the various headings of the various documents may be part of a standard form and may be pre-translated. The business transaction terms that are unique to the business transaction may be translated using the techniques previously described and then placed into the various boxes in the form. Other examples of documents that have been translated into Chinese are illustrated in FIGS. 12 and 13. In FIG. 12, a haulier booking form is illustrated where the key business terms have been translated into Chinese and are shown along with the English translations. FIG. 13 illustrates a sales order confirmation that also include the key business terms translated into Chinese.

The invention has now been described in detail for purposes of clarity and understanding. However, it will be appreciated that certain changes and modifications may be practiced within the scope of the appended claims.

What is claimed is:

1. A method for providing business transaction information in different languages, the method comprising:
inputting business transaction information that is in a first language into a computer having a processor, wherein the business transaction information is input in the form of words and/or characters of the first language;
saving the business transaction information into fields of a database based on certain categories of the business transaction information;
translating the business transaction information in at least some of the fields to a second language by performing a look-up in the database to determine corresponding words and/or characters of the second language; and
producing a document having at least some of the business transaction information in the second language.

2. A method as in claim 1, wherein the business transaction information comprises an order to purchase an item, and wherein the document comprises a confirmation of the order.

3. A method as in claim 2, further comprising printing the order confirmation.

4. A method as in claim 1, wherein the fields are selected from a group consisting of customer names, product names, product descriptions, and addresses.

5. A method as in claim 1, wherein the first language comprises English and the second language comprises a Far Eastern language.

6. A method as in claim 1, wherein the computer further includes a display screen, and further comprising displaying on the display screen an entry region corresponding to each category.

7. A method for providing business transaction information in different languages, the method comprising:
receiving an electronic document containing business transaction information in words and/or characters of a first language;
saving the business transaction information into fields of a database based on certain categories of the business transaction information;
translating the business transaction information in at least some of the fields to a second language by performing a look-up in the database to determine corresponding words and/or characters of the second language; and
producing an electronic document having at least some of the business transaction information in the second language.

8. A method as in claim 7, further comprising sending the produced electronic document to a printer.

9. A method as in claim 7, further comprising receiving the business transaction information from an electronic input device.

10. A method as in claim 7, wherein the business transaction information comprises an order to purchase an item, and wherein the produced document comprises a confirmation of the order.

11. A method as in claim 7, wherein the fields are selected from a group consisting of customer names, product names, product descriptions, and addresses.

12. A method as in claim 7, wherein the first language comprises English and the second language comprises a Far Eastern language.

13. A system for translating business transaction information into different languages, the system comprising:
a database having a collection of certain words and/or characters from a first language and counterpart words and/or characters from one or more other languages;
computer code to translate words and/or characters from fields having business transaction information from the first language to a second language; and
computer code to produce an electronic document containing at least some of the business transaction information in the second language.

14. A system as in claim 13, further comprising an electronic input device for inputting the business transaction information.

15. A system as in claim 13, further comprising a printer to print the produced electronic document.

16. A system as in claim 13, wherein the business transaction information comprises an order to purchase an item, and wherein the produced document comprises a confirmation of the order.

17. A system as in claim 13, wherein the fields are selected from a group consisting of customer names, product names, product descriptions, and addresses.

18. A system as in claim 13, wherein the first language comprises English and the second language comprises a Far Eastern language.
